(19) United States
(12) Patent Application Publication
(10) Pub. No.: US 2012/0268427 A1
(43) Pub. Date: Oct. 25, 2012

(54) Optical Filtered Sensor-In-Pixel Technology for Touch Sensing

(75) Inventor: David Elliott Slobodin, Lake Oswego, OR (US)

(73) Assignee: PERCEPTIVE PIXEL INC., New York, NY (US)

(21) Appl. No.: 13/451,090

(22) Filed: Apr. 19, 2012

Related U.S. Application Data
(60) Provisional application No. 61/477,007, filed on Apr. 19, 2011.

(51) Int. Cl. G06F 3/042

(52) U.S. Cl. 345/175

(57) ABSTRACT

Optical filtered sensor-in-pixel technology for touch sensing, in which a waveguide receives infrared light emitted by a light source and causes at least some of the received infrared light to undergo total internal reflection within the waveguide. A frustrating layer is disposed relative to the waveguide so as to contact the waveguide when a touch input is provided. The frustrating layer causes frustration of the total internal reflection of the received infrared light within the waveguide at a contact point between the frustrating layer and the waveguide. A sensor-in-pixel display displays an image that is perceivable through the waveguide and the frustrating layer and includes photosensors. The photosensors have a photosensor corresponding to each pixel of the image and sense at least some of the infrared light that escapes from the waveguide at the contact point.

### CROSS REFERENCE TO RELATED APPLICATIONS

The present application claims the benefit of U.S. Provisional Application No. 61/477,007, filed Apr. 19, 2011, which is incorporated herein by reference in its entirety for all purposes.

### TECHNICAL FIELD

This disclosure relates to optical filtered sensor-in-pixel technology for touch sensing.

### BACKGROUND

Liquid crystal displays (LCD's) with integrated photosensors are under development to enable touch input capability within a slim form-factor and with low cost. Sensor-in-pixel (SIP) LCD's incorporating hydrogenated amorphous silicon (a-Si:H) photodiodes or phototransistors within the thin film transistor (TFT) substrate have been disclosed previously by others (e.g., Abileah and Den Boer). These device structures take advantage of the a-Si:H layer already present in the TFT plate. A potential disadvantage of this design is that the touch signal-noise-ratio (SNR) may be heavily affected by visible ambient light intensity and the displayed image, since visible light from the displayed image can be reflected back toward the LCD TFT substrate from the various optical layers in the color filter substrate. This may lead to unpredictable operation and false touches. In addition, a clear touch threshold point may not exist—a touch can be registered without the finger touching the display.

### SUMMARY

Techniques are described for optical filtered sensor-in-pixel technology for touch sensing.

In one aspect, a touch-sensitive display device includes an infrared light source, a waveguide configured to receive infrared light emitted by the light source and to cause at least some of the received infrared light to undergo total internal reflection within the waveguide, and a frustrating layer disposed relative to the waveguide so as to contact the waveguide when a touch input is provided. The frustrating layer is configured to cause frustration of the total internal reflection of the received infrared light within the waveguide at a contact point between the frustrating layer and the waveguide such that some of the received infrared light undergoing total internal reflection within the waveguide escapes from the waveguide at the contact point. The touch-sensitive display device also includes a sensor-in-pixel display configured to display an image that is perceivable through the waveguide and the frustrating layer and including photosensors. The photosensors have a photosensor corresponding to each pixel of the image and are configured to sense at least some of the infrared light that escapes from the waveguide at the contact point.

Implementations may include one or more of the following features. For example, each of the photosensors may be sensitive to infrared light and less sensitive to visible light as compared to infrared light. In this example, each of the photosensors may be sensitive to infrared light and insensitive to visible light.

Each of the photosensors may include a first layer that is configured to absorb visible light and transmit infrared light and a second layer that is configured to sense infrared light transmitted through the first layer. Each of the photosensors may include a first layer that is configured to absorb light having a wavelength between 400 and 700 nanometers and transmit light having a wavelength longer than 700 nanometers and a second layer that is configured to sense light having a wavelength between 700 and 880 nanometers that is transmitted through the first layer.

Each of the photosensors may include a hydrogenated silicon germanium alloy (a-SiGe:H). Each of the photosensors may include microcrystalline silicon. Each of the photosensors may include a first layer with an effective bandgap of 1.7 to 1.8 eV and a second layer that is configured to sense light transmitted through the first layer.

Each of the photosensors may include a first layer that has a thickness of about 0.2 to 0.5 microns and comprises highly doped p-type amorphous silicon and a second layer that is configured to sense light transmitted through the first layer and that comprises at least one of a hydrogenated silicon germanium alloy (a-SiGe:H) and microcrystalline silicon. Each of the photosensors may include a first layer that has a thickness of about 0.2 to 0.5 microns and comprises highly doped n-type amorphous silicon and a second layer that is configured to sense light transmitted through the first layer and that comprises at least one of a hydrogenated silicon germanium alloy (a-SiGe:H) and microcrystalline silicon.

In some examples, each of the photosensors may include a first layer that comprises a ternary alloy and a second layer that is configured to sense light transmitted through the first layer and that comprises at least one of a hydrogenated silicon germanium alloy (a-SiGe:H) and microcrystalline silicon. In these examples, the ternary alloy may include a ratio of germanium and nitrogen (a-SiGeN), a ratio of germanium and oxygen (a-SiGeO), a ratio of germanium and carbon (a-SiGeC:H), or an a-SiGeN:H layer.

In some implementations, the frustrating layer may be a pliable frustrating layer disposed relative to the waveguide so as to enable the pliable frustrating layer to contact the waveguide when the pliable frustrating layer is physically deformed. In these implementations, the pliable frustrating layer may be configured to cause frustration of the total internal reflection of the received infrared light within the waveguide at a contact point between the pliable frustrating layer and the waveguide when the pliable frustrating layer is physically deformed to contact the waveguide such that some of the received infrared light undergoing total internal reflection within the waveguide escapes from the waveguide at the contact point. Further, in these implementations, the waveguide may contact the sensor-in-pixel display.

In some examples, the waveguide may be a pliable waveguide, the frustrating layer may be disposed relative to the pliable waveguide so as to enable the frustrating layer to contact the pliable waveguide when the pliable waveguide is physically deformed, and the frustrating layer may be configured to cause frustration of the total internal reflection of the received infrared light within the pliable waveguide at a contact point between the frustrating layer and the pliable waveguide when the pliable waveguide is physically deformed to contact the frustrating layer such that some of the received infrared light undergoing total internal reflection within the pliable waveguide escapes from the pliable waveguide at the contact point. In these examples, the frustrating layer may contact the sensor-in-pixel display.

Further, the touch-sensitive display device may include a cladding layer positioned to receive a touch input and cause the waveguide and the frustrating layer to contact based on the touch input. Each of the photosensors may include a photodetector that includes a first layer configured to filter visible light and a second layer configured to sense infrared light transmitted through the first layer. Electricity generated by the photodetector in sensing infrared light may flow through each of the first layer and the second layer. In addition, each of the photosensors may include a first layer configured to filter visible light and a photodetector that includes a second layer configured to sense infrared light transmitted through the first layer. The first layer may be positioned as a window over the photodetector and electricity generated by the photodetector in sensing infrared light may flow through the second layer, but may not flow through the first layer.

Implementations of the described techniques may include hardware, a method or process implemented at least partially in hardware, or a computer-readable storage medium encoded with executable instructions that, when executed by a processor, perform operations.

The details of one or more implementations are set forth in the accompanying drawings and the description below. Other features will be apparent from the description and drawings, and from the claims.

### DESCRIPTION OF DRAWINGS

FIG. 1 is a schematic cross-sectional diagram of an example touch-sensitive display.

FIGS. 2A and 3 are schematic cross-sectional diagrams of examples of a frustrated total internal reflection layer.

FIG. 2B is a schematic cross-sectional diagram of an example of a cladding layer. FIG. 4 is a diagram of an example photosensor array.

FIG. 5 is a graph that illustrates quantum efficiency versus wavelength for solar cells with photosensitive layers having a range of bandgaps.

FIGS. 6 and 7 are schematic cross-sectional diagrams of examples of photosensors.

### DETAILED DESCRIPTION

To reduce ambient light SNR and touch threshold problems, it may be desirable to integrate frustrated total internal reflection (FTIR) technology with an SIP LCD. To integrate FTIR touch sensing technology with a sensor-in-pixel display, it may be further desirable to make the SIP sensor sensitive to infrared (IR) light only (and insensitive to visible light from ambient sources and visible light reflected from the displayed image). In some implementations of FTIR, IR light emerges from a waveguide excited with trapped IR light where a touch frustrates total internal reflection. In these implementations, the IR light escapes the waveguide at a point of contact and may be detected by photosensors in an SIP LCD if the photosensors are sensitive to IR light. In a typical FTIR configuration, a top film containing an IR filter is used to reduce ambient light from interfering with the touch SNR. This may be used with an SIP LCD provided the SIP is not sensitive to visible light that necessarily does penetrate the top sheet because the top sheet must transmit visible light so people can view the displayed image. Even without the ambient light impact, an issue may still exist with reflected visible light from the displayed image even in this implementation. This may be remedied by making the SIP insensitive to visible light.

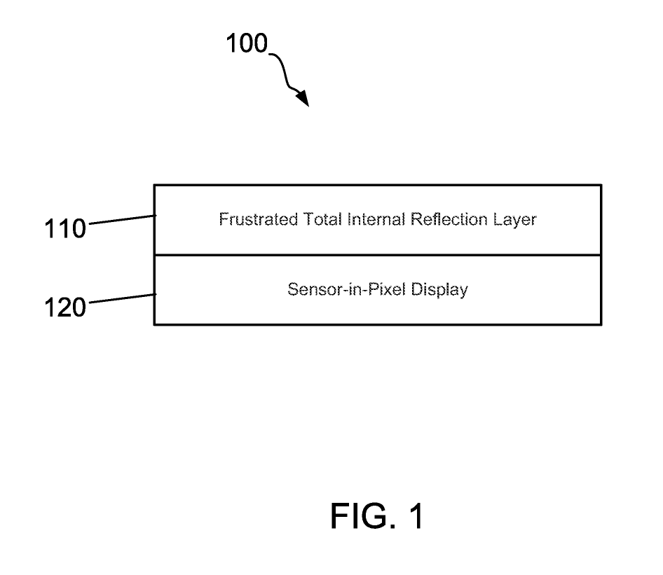

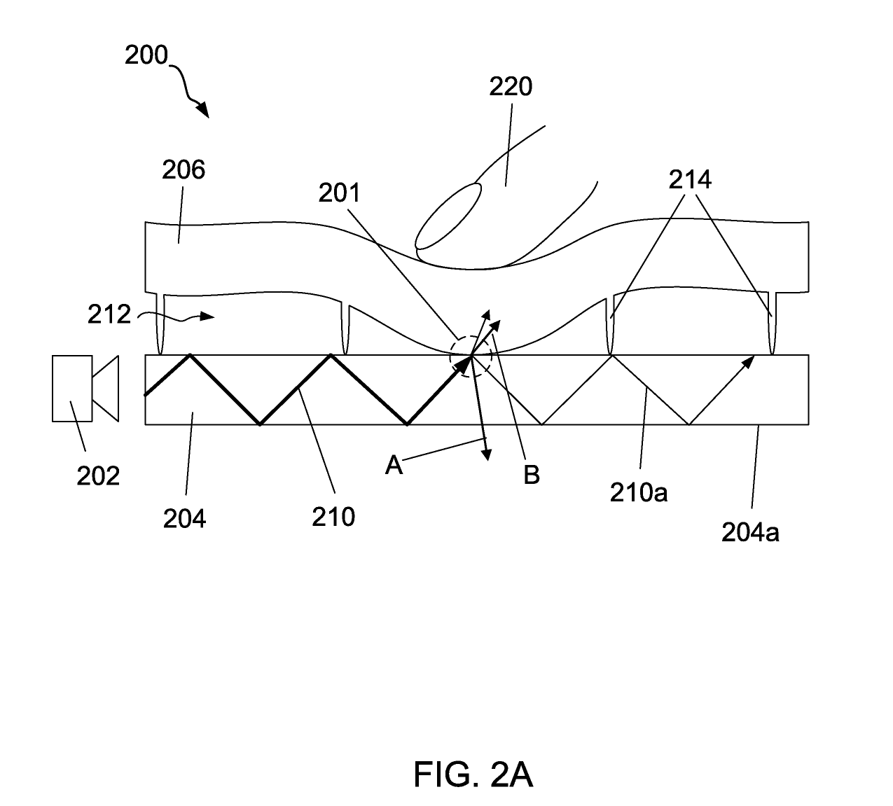

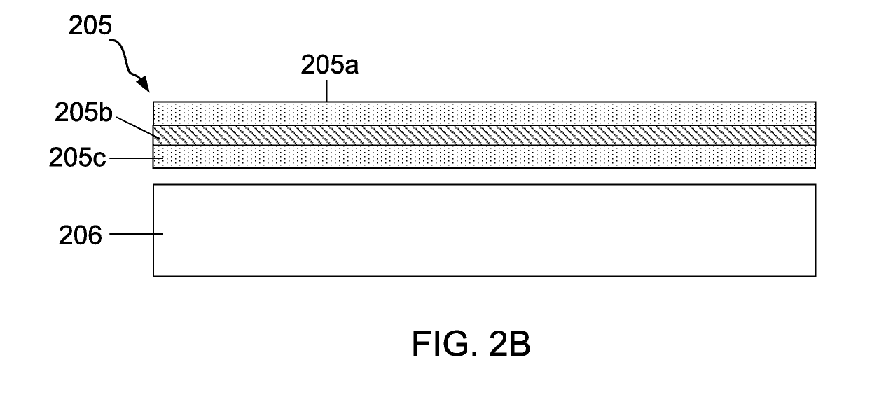

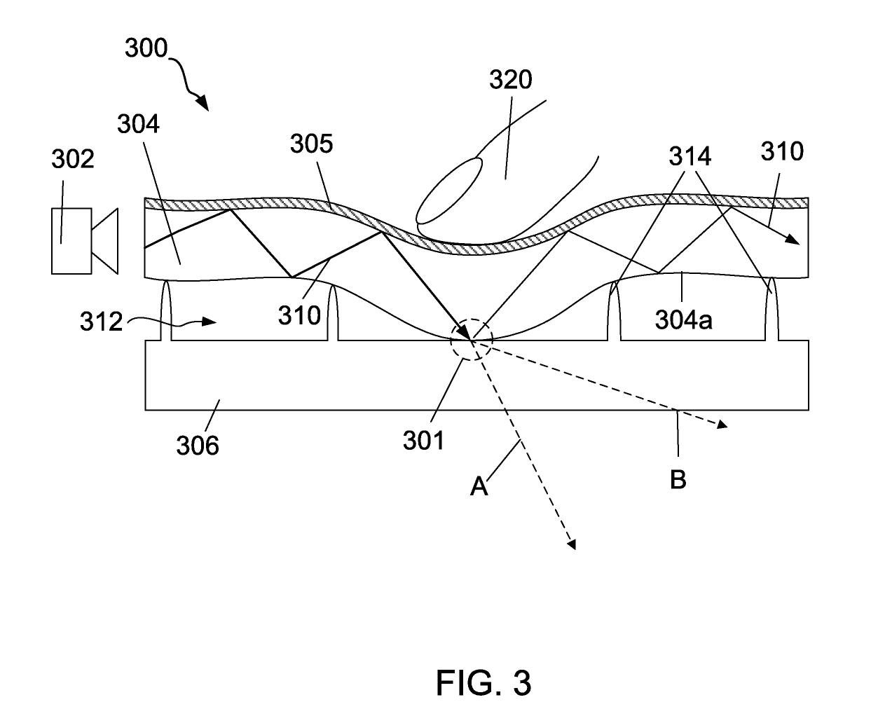

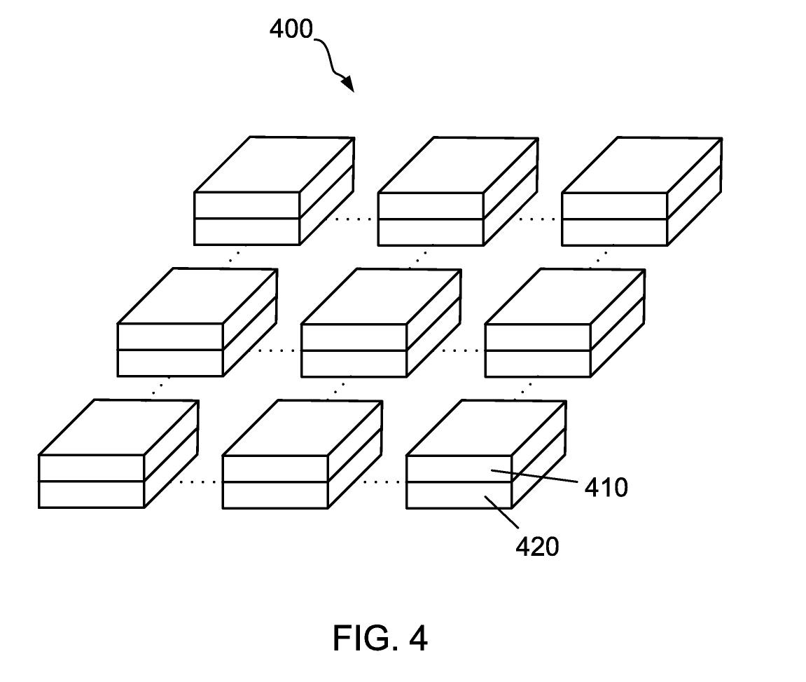

FIG. 1 illustrates an example touch-sensitive display 100. The touch-sensitive display 100 includes an FTIR layer 110 and an SIP display 120. The FTIR layer 110 may include a light source, a waveguide, and a frustrating layer. The light source injects light (e.g., infrared light) into the waveguide and the injected light undergoes total internal reflection within the waveguide. When a touch input is provided to the FTIR layer 110, the waveguide and the frustrating layer contact to cause frustration of the total internal reflection of light within the waveguide. The frustration of the total internal reflection of light within the waveguide causes at least some of the light within the waveguide to escape at the contact point. The escaped light may be sensed to detect the occurrence and location of the touch input being provided to the FTIR layer 110. The FTIR layer 110 may be any type of FTIR implementation. More detailed examples of FTIR layers are described below with respect to FIGS. 2A to 3.

The SIP display 120 is a sensor-in-pixel display that displays an image through the FTIR layer 110. The SIP display 120 includes a photosensor at each pixel of the image displayed by the SIP display 120. The photosensors of the SIP display 120 detect light (e.g., infrared light) that escapes from the FTIR layer 110 when a touch input is provided to the FTIR layer 110. The SIP display 120 determines occurrence and location of a touch input based of which of the photosensors of the SIP display 120 detect light that has escaped from the FTIR layer 110. The SIP display 120 may be any type of sensor-in-pixel display. For instance, the SIP display 120 may be an SIP LCD or an SIP organic light emitting diode (OLED) display. The SIP display 120 may contact the FTIR layer 110 (e.g., may be optically adhered to the FTIR layer 110) or may be spaced apart from the FTIR layer 110 by an air gap (e.g., a small air gap defined by microscopic roughness on a surface of the FTIR layer 110 and/or the SIP display 120).

The sensor output of the SIP display 120 is supplied to a suitable computer or other electronic device capable of handling various well-known image-processing operations, such as rectification, background subtraction, noise removal, and analysis for each frame.

Machine vision tracking techniques then may be employed by the computer or other electronic device to translate the captured sensor data into discrete touch events and strokes. Such processing may be carried out by any suitable computing system.

FIG. 2A illustrates an example FTIR layer 200. As shown, the FTIR layer 200 includes a radiation source 202, a waveguide 204, and a pliable frustrating layer 206 above waveguide 204. Pliable frustrating layer 206 is positioned relative to waveguide 204 such that a small gap 212 exists between pliable frustrating layer 206 and waveguide 204. In some implementations, protrusions 214 may be formed on or as part of frustrating layer 206 to maintain the gap 212 between the pliable frustrating layer 206 and the waveguide 204. In such implementations, protrusions 214 (e.g., surface roughness) can be formed integrally with pliable frustrating layer 206, i.e., protrusions 214, together with frustrating layer 206, form a single mass of seamless, contiguous material.

In some implementations, protrusions 214 are a result of the micro-roughness that exists on the surface of frustrating layer 206 in which the spacing between protrusions 214 is random or semi-random. In some cases, protrusions 214 are formed from material distinct from frustrating layer 206. For example, glass spacers could be used to separate an acrylic waveguide from a polycarbonate frustrating layer. The spacing between protrusions 214 can be random, pseudo-random or periodic.

Electromagnetic radiation (e.g., infrared (IR) radiation) is emitted from radiation source 202 and coupled into waveguide 204. Due to the refractive index difference between waveguide 204 and the medium surrounding waveguide 204, at least some of the coupled radiation then undergoes TIR and proceeds to travel down waveguide 204. For example, waveguide 204 could be formed from a layer of acrylic surrounded by air. Given the refractive index difference between acrylic (n=1.49) and air (n=1.0), radiation introduced by radiation source 202 into waveguide 204 at an appropriate angle of incidence propagates within and along the acrylic layer by TIR.

In order to frustrate TIR of radiation propagating in waveguide 204, pliable frustrating layer 206 is formed from material that has a refractive index comparable to waveguide 204 and is flexible enough to respond to pressure applied by an input such that sufficient contact can be made with waveguide layer 204. For example, pliable frustrating layer 206 can be formed from relatively pliable materials such as polyvinyl butyral (PVB). Frustrating layer 206 can be formed of other materials including, but not limited to, acrylic/polymethylmethacrylate (PMMA), polyethylene terrephthalate (PET), polycarbonate (PC), polyvinyl chloride (PVC), transparent polyurethane (TPU), or triacetate cellulose (TAC). Thus, when frustrating layer 206 comes into contact with waveguide layer 204, at least a portion of the radiation propagating due to TIR is “frustrated” and escapes from waveguide 204. In some cases, at least a portion 210a of radiation 210 continues to propagate by TIR in waveguide 204, as shown in FIG. 2A. In addition, when integrated as part of a display, frustrating layer 206 may be formed from a material that is transparent to the range of wavelengths emitted by a display light source. For example, PVB is highly transmissive in both the visible and near-infrared regions of the spectrum.

In some implementations, frustrating layer 206 may be configured to have a substantially uniform thickness that is within a range of approximately 100 μm through 300 μm. In selecting an appropriate thickness for frustrating layer 206, the following considerations may be taken into account. If frustrating layer 206 is too thin, it may be difficult to manipulate and handle, for example, during manufacturing. On the other hand, if frustrating layer 206 is too thick, it may cause a parallax issue, where a user perceives a point of contact to be displaced (e.g., by the thickness of frustrating layer 206) from the actual object (produced by a display light source) with which the user is attempting to interact. In alternative implementations, frustrating layer 206 may be configured to be thinner than 100 μm (e.g., about 10 μm or about 30 μm) or thicker than 300 μm (e.g., about 1 mm or about 2 mm).

Due to the presence of air gap 212 between pliable frustrating layer 206 and waveguide 204, little or no frustration of TIR within waveguide 204 occurs absent some external stimulus. However, when pliable frustrating layer 206 is depressed by, for example, a user's finger 220, a portion of pliable frustrating layer 206 contacts waveguide layer 204 in a region 201 (identified by dashed line circle) corresponding to the point of depression. When the portion of pliable frustrating layer 206 contacts waveguide 204, total internal reflection within waveguide 204 is frustrated at region 201, causing at least some radiation to escape from the waveguide 204. It should be noted that although protrusions 214 contact waveguide 204, the area of contact between protrusions 214 and waveguide 204, when no pressure is applied to frustrating layer 206, is relatively small compared to the area of contact between layer 206 and waveguide 204 when frustrating layer 206 is depressed. Accordingly, frustration of TIR that might occur in the regions of contact between protrusions 214 and waveguide 204 is negligible when no pressure is applied to frustrating layer 206.

As shown in FIG. 2A, some of the radiation, represented by arrow “A,” escapes from surface 204a of waveguide 204. The SIP display 120 images the radiation that escapes from surface 204a. As a result, the SIP display 120 can discriminately sense, for successive instants of time, points of contact that are sufficiently forceful to deform pliable frustrating layer 206 such that it contacts a substantial portion of waveguide 204 relative to the portion of waveguide 204 contacted by frustrating layer 206 when no pressure is applied. That is, for a “single” point of contact on pliable frustrating layer 206, such as contact by finger 220 shown in FIG. 2A, a single “area” of contact corresponding to the area of pliable frustrating layer 206 that comes into contact with waveguide 204 is discriminately sensed by the SIP display 120. Likewise, when two or more objects (e.g., two or more fingers of a user) contact and depress pliable frustrating layer 206 concurrently, multiple areas of contact are discriminately (and concurrently) sensed by the SIP display 120. For ease of discussion, the term “a point of contact” may be used throughout this disclosure to refer more generally to any region or area at which contact is made.

Radiation source 202 can include multiple light emitting diodes (LEDs), which are arranged directly against an edge of waveguide 204 so as to maximize coupling of electromagnetic radiation into total internal reflection. Other sources of electromagnetic radiation, such as, for example, laser diodes, may be used instead. In some implementations, source 202 can be selected to emit radiation in the infrared (IR) portion of the electromagnetic spectrum such that it does not interfere with visible radiation.

In some implementations, waveguide 204 is formed from materials that support TIR of infrared light but that also are transparent (or at least transmissive) to the range of wavelengths emitted by a display light source so as to minimize interference with the display. For example, waveguide 204 can be formed from materials including glass or plastics such as acrylic. Waveguide 204 also can be formed from materials including, but not limited to, PMMA, PC, PVC, PVB, TPU, or PET. Locally depressing frustrating layer 206 may cause substantial local deformation of waveguide layer 204 or frustrating layer 206 as frustrating layer 206 comes into contact with waveguide layer 204. In contrast, portions of waveguide layer 204 or frustrating layer 206 far from the region of contact between waveguide 204 and frustrating layer 206 may experience little or no deformation. Such pronounced local deformation may lead to an increase in the area of physical contact between compliant frustrating layer 206 and waveguide layer 204, thereby causing an increased amount of IR to escape from waveguide 204 in the region of the point of contact. In some cases, the edges of waveguide 204 are polished to maximize TIR coupling of radiation from source 202.

In some implementations, waveguide 204 may be configured to have a substantially uniform thickness that is within a range of approximately 0.5 mm through 20 mm. In selecting an appropriate thickness for waveguide 204, the following considerations may be taken into account. In some cases, if waveguide 204 is too thin, it may not provide a sufficiently rigid surface, e.g., the waveguide may bend excessively with typical contact force expected to be applied during use. Alternatively, or in addition, an insufficient amount of light may be coupled into the waveguide. In some cases, if waveguide 204 is too thick, this may lead to an increase in the weight and cost. Alternatively, or in addition, the touch-view parallax may be excessive.

In some implementations, a cladding layer may be positioned on or above a surface of frustrating layer 206. FIG. 2B illustrates an example of a cladding layer 205 positioned above a frustrating layer 206. Cladding layer 205 may protect frustrating layer 206 from damage and/or contamination when frustrating layer 206 is contacted by an object such as a finger or stylus. When integrated as part of a display, cladding layer 205 also is transparent (or at least transmissive) to the range of wavelengths emitted by a display light source.

As shown in the example of FIG. 2B, cladding layer 205 may include an anti-glare layer 205a, an infrared (IR) filter 205b and a non-wetting layer 205c. IR filter layer 205b filters out ambient IR light incident on cladding layer 205 so as to reduce (e.g., prevent) occurrences in which ambient IR light is erroneously detected as a point of contact. An example of material that can be used in an IR filter layer includes ClearAS, commercially available from Sumitomo Osaka Cement Co., Ltd. Anti-glare layer 205a is a scratch-resistant, low friction film disposed on a top surface of IR filter layer 205b. A film that can be used as an anti-glare layer includes, for example, a textured polyester film such as Autotex, which is commercially available from MacDermid Inc.

In some cases, substantial regions of cladding layer 205 may contact frustrating layer 206 such that cladding layer 205 appears to “wet” frustrating layer 206. Such regions of “wetting” may alter the amount of visible light that is reflected between frustrating layer 206 and cladding layer 205, resulting in portions of touch-sensitive device 200 that appear as blotches when dark images are displayed. By forming anti-wetting layer 205c on a bottom surface of IR filter layer 205b, however, the size and number of wetting regions may be reduced. Similar to anti-glare layer 205a, anti-wetting layer 205c also may be a polyester film, such as Autotex. In some cases, a surface frustrating layer 206 is sufficiently rough such that it is not necessary to include an anti-wetting layer 205c in cladding layer 205. Alternatively, in some cases, cladding layer 205 can be formed of a single film of polytetrafluoroethylene (PTFE) or acrylic film.

The films in cladding layer 205 may be bonded together using, for example, an optical adhesive. In the example of FIG. 2B, an air gap exists between cladding layer 205 and frustrating layer 206. The air gap between cladding layer 205 and frustrating layer 206 may be maintained using, for example, the surface roughness of the bottom surface of cladding layer 205 (e.g., surface roughness of the non-wetting layer 205c) or the surface roughness of frustrating layer 206.

As illustrated in FIG. 2A, radiation that escapes waveguide 204, due to FTIR when frustrating layer 206 contacts waveguide 204, may travel in many different directions due to, for example, the surface texture of frustrating layer 206, bulk scattering within frustrating layer 206, or incomplete contact between waveguide 204 and frustrating layer 206. For instance, some of the radiation that escapes may travel in a direction towards frustrating layer 206, as shown by arrow “B” in FIG. 2A, while some of the radiation may travel away from frustrating layer 206, as shown by arrow “A” in FIG. 2A. If the refractive indices of frustrating layer 206 and waveguide 204 are comparable, then a portion of radiation will escape in a direction that is parallel or substantially parallel (e.g., within 10° or less, 20° or less, 30° or less, or 45° or less, depending on the difference in index of refraction between frustrating layer 206 and waveguide 204) to a direction the radiation was traveling in waveguide 204 just prior to frustration of TIR, as shown by arrow “B” in FIG. 2A. As a result, a portion of the escaped radiation may never reach the SIP display 120. One approach to enable capture of a sufficient amount of light from the frustrated TIR light to detect a point of contact, despite the large fraction of escaped radiation that may never be imaged, may be to increase the intensity of the radiation injected into waveguide 204. This approach, however, may cause operating efficiency to be diminished. Therefore, an alternative approach may be to configure frustrating layer 206 to collect and/or steer at least a portion of radiation that escapes waveguide 204 toward the SIP display 120.

In implementations in which compliant frustrating layer 206 is configured to collect and/or steer radiation (that escapes waveguide 204 and that is incident on frustrating layer 206) toward the SIP display 120, frustrating layer 206 may be configured to steer escaped radiation within a range of angles such that the escaped radiation is steered towards a position on the SIP display 120 that is substantially beneath the point of contact between waveguide 204 and pliable frustrating layer 206. By collecting and steering radiation towards the SIP display 120, the operating efficiency may be increased. As a result, less powerful radiation sources 202 may be used. Furthermore, by steering more of the FTIR escaped radiation towards the SIP display 120, the probability of failing to sense contact may be reduced.

The frustrating layer may be formed from an engineered material having light-steering microstructures formed within or on a surface of the engineered material, with the light-steering microstructures being configured to steer radiation/light in one or more particular directions. Various implementations of such engineered materials and light-steering microstructures for re-directing radiation that escapes from waveguide 204 may be employed within or on a pliable frustrating layer. For example, a reflective coating may be formed on the pliable frustrating layer to reflect radiation that escapes from the waveguide back inside of the device. Any of the techniques and structures described in co-pending, commonly owned U.S. patent application Ser. No. 12/757,937, entitled “Touch Sensing,” filed Apr. 9, 2010, which is incorporated herein by reference in its entirety for all purposes, may be applied to the frustrating layer 206.

FIG. 3 illustrates another example FTIR layer 300. As shown, the FTIR layer 300 includes a radiation source 302, a pliable waveguide 304, and a frustrating layer 306 adjacent to waveguide 304. Frustrating layer 306 is positioned relative to the pliable waveguide 304 such that a small gap 312 exists between frustrating layer 306 and pliable waveguide 304. In some implementations, protrusions 314 may be formed on or as part of frustrating layer 306 to maintain the gap 312 between the pliable waveguide 304 and the frustrating layer 306. In such implementations, protrusions 314 (e.g., surface roughness) can be formed integrally with frustrating layer 306, i.e., protrusions 314, together with frustrating layer 306, form a single mass of seamless, contiguous material. In some implementations, a micro-roughness layer having randomly (or semi-randomly) spaced protrusions may be formed on the surface of the frustrating layer 306, which function substantially as protrusions 314. In some cases, protrusions 314 are formed from material distinct from frustrating layer 306 and/or waveguide 304. For example, glass spacers could be used to separate an acrylic waveguide from a polycarbonate frustrating layer. The spacing between protrusions 314 can be random, pseudo-random or periodic.

Electromagnetic radiation (e.g., infrared (IR) radiation) is emitted from radiation source 302 and coupled into pliable waveguide 304. Due to the refractive index difference between pliable waveguide 304 and the medium surrounding waveguide 304, at least some of the coupled radiation then undergoes TIR and proceeds to travel down pliable waveguide 304. For example, waveguide 304 could be formed from a thin layer of compliant acrylic surrounded by air. Given the refractive index difference between acrylic (n=1.49) and air (n=1.0), radiation introduced by radiation source 302 into waveguide 304 at an appropriate angle of incidence propagates within and along the acrylic layer by TIR.

Waveguide 304 is formed from a material that is flexible enough to respond to pressure applied by an input such that sufficient contact can be made with frustrating layer 306. For example, waveguide 304 can be formed from materials such as acrylic/polymethylmethacrylate (PMMA), polycarbonate (PC), polyethylene terephthalate (PET) or transparent polyurethane (TPU). Other materials can be used as well.

In order to frustrate TIR of radiation propagating in waveguide 304, frustrating layer 306 is formed from material that has a refractive index comparable to or higher than compliant waveguide 304. Thus, when compliant waveguide 304 comes into contact with frustrating layer 306, at least a portion of the radiation propagating down waveguide 304 due to TIR is “frustrated” and escapes from waveguide 304. In some cases, at least a portion of radiation 310 continues to propagate by TIR in waveguide 304, as shown in FIG. 3. Either a rigid or non-rigid material can be used to form frustrating layer 306. In addition, when integrated as part of a display, frustrating layer 306 may be formed from a material that is transparent (or at least transmissive) to the range of wavelengths emitted by a display light source. For example, frustrating layer 306 may be formed from glass or from PMMA, both of which are generally transmissive in both the visible and near-infrared regions of the spectrum. Alternatively, frustrating layer 306 can be formed from relatively pliable materials such as polyvinyl chloride (PVC), polyvinyl butyral (PVB), TPU, or from more rigid materials such as PET or PC. Other materials can be used as well.

Locally depressing waveguide 304 may cause substantial local deformation of frustrating layer 306 as waveguide 304 comes into contact with frustrating layer 306. In contrast, portions of frustrating layer 306 far from the region of contact between waveguide 304 and frustrating layer 306 may experience little or no deformation. Such pronounced local deformation may lead to an increase in the area of physical contact between compliant waveguide 304 and frustrating layer 306, thereby causing an increased amount of IR to escape from compliant waveguide 304 in the region of the point of contact.

In some implementations, frustrating layer 306 may be configured to have a substantially uniform thickness that is within a range of approximately 100 μm through 300 μm. In selecting an appropriate thickness for frustrating layer 306, the following considerations may be taken into account. If frustrating layer 306 is too thin, it may be difficult to manipulate and handle, for example, during manufacturing. On the other hand, if frustrating layer 306 is too thick, it may cause a parallax issue, where a user perceives a point of contact to be displaced (e.g., by the thickness of frustrating layer 306) from the actual displayed object with which the user is attempting to interact. In alternative implementations, frustrating layer 306 may be configured to be thinner than 100 μm (e.g., about 10 μm or about 30 μm) or thicker than 300 μm (e.g., about 1 mm or about 2 mm).

Due to the presence of air gap 312 between frustrating layer 306 and pliable waveguide 304, little or no frustration of TIR within waveguide 304 occurs absent some external stimulus. However, when pliable waveguide 304 is depressed by, for example, a user's finger 320, a portion of pliable waveguide 304 contacts frustrating layer 306 in a region 301 (identified by dashed line circle) corresponding to the point of depression. As described above, in some implementations, the contact between pliable waveguide 304 and frustrating layer 306 may cause local deformation of frustrating layer 306. When frustrating layer 306 contacts waveguide 204, total internal reflection within waveguide 304 is frustrated within region 301 causing at least some radiation to escape from the pliable waveguide 304. It should be noted that although protrusions 314 also contact waveguide 304, the area of contact between protrusions 314 and waveguide 304, when no pressure is applied to pliable waveguide 304, is relatively small compared to the area of contact between frustrating layer 306 and pliable waveguide 304 when pliable waveguide 304 is depressed. Accordingly, frustration of TIR that might occur in the regions of contact between protrusions 314 and waveguide 304 is negligible when no pressure is applied to pliable waveguide 304.

As shown in FIG. 3, some of the radiation, represented by arrows “A,” escapes from surface 304a of pliable waveguide 304 and travels in a direction towards the SIP display 120. The SIP display 120 images the radiation that escapes from surface 304a. As a result, the

SIP display 120 can discriminately sense, for successive instants of time, points of contact that are sufficiently forceful to deform pliable waveguide 304 such that it contacts a substantial portion of frustrating layer 306 relative to the portion of frustrating layer 306 contacted by waveguide 304 when no pressure is applied. That is, for a “single” point of contact on waveguide 304, such as contact by finger 320 shown in FIG. 3, a single “area” of contact corresponding to the portion of frustrating layer 306 that contacts waveguide 304 is discriminately sensed by the SIP display 120. Likewise, when two or more objects (e.g., two or more fingers of a user) contact and depress waveguide 304 concurrently, multiple areas of contact are discriminately (and concurrently) sensed. For ease of discussion, the term “a point of contact” may be used throughout this disclosure to refer more generally to any region or area at which contact is made.

Radiation source 302 can include multiple light emitting diodes (LEDs), which are arranged directly against an edge of waveguide 304 so as to maximize coupling of electromagnetic radiation into total internal reflection. Other sources of electromagnetic radiation, such as, for example, laser diodes, may be used instead. In some implementations, source 302 can be selected to emit radiation in the infrared (IR) portion of the electromagnetic spectrum such that its emissions do not interfere with visible light.

In some implementations, pliable waveguide 304 is formed from materials that support TIR of infrared light. In addition, when integrated as part of a display, pliable waveguide 304 may be selected so as to be transparent (or at least transmissive) to the range of wavelengths emitted by a display light source so as to minimize interference with the display. In some cases, the edges of pliable waveguide 304 are polished to maximize TIR coupling of radiation from source 302.

In some implementations, waveguide 304 may be configured to have a substantially uniform thickness that is within a range of approximately 0.50 mm through 2 mm. In selecting an appropriate thickness for waveguide 304, the following considerations may be taken into account. If waveguide 304 is too thin, an insufficient amount of radiation may be coupled into waveguide 304 from source 302. In implementations that utilize one or more lasers for light source 302, however, it may be possible to use a thinner waveguide 304 and still have a sufficient amount of radiation couple into the waveguide 304 than in implementations that utilize one or more LEDs as light source 302. Alternatively, if waveguide 304 is too thick, the waveguide deformation in response to a light touch may not be sufficient to create enough radiation outcoupling for the touch to be detected. In addition, it may degrade the quality of output images displayed by the device and create excessive touch parallax.

In some cases, contacting waveguide 304 with a finger, stylus or other object can cause inadvertent frustration of total internal reflection within waveguide 304 even if waveguide 304 is not depressed enough to come into contact with frustrating layer 306. In addition, such objects may damage waveguide 304. Accordingly, in some implementations, a cladding layer 305 is positioned on top of pliable waveguide 304, either in optical contact with waveguide 304 or layered with a thin air gap between cladding layer 305 and waveguide 304. If the cladding layer is in optical contact with the waveguide, cladding layer 305 is formed of a material that has a refractive index lower than waveguide 304 to maintain total internal reflection of radiation within waveguide 304. Cladding layer 305 may reduce (e.g., prevent) the occurrence of inadvertent FTIR and serves as a barrier between waveguide 304 and a contacting object. In addition, cladding layer 305 protects waveguide 304 from damage and/or contamination when waveguide 304 is contacted by an object such as a finger or stylus. When integrated as part of a display, cladding layer 305 also is transparent (or at least transmissive) to the range of wavelengths emitted by a display light source. For example, cladding layer can be formed of polytetrafluoroethylene (PTFE) or acrylic film.

In some implementations, the cladding layer 305 includes multiple layers. The cladding layer described above with respect to FIG. 2B may be used as the cladding layer 305.

As illustrated in FIG. 3, radiation that escapes compliant waveguide 304 due to FTIR when the compliant waveguide 304 contacts frustrating layer 306 may travel in many different directions due to, for example, the surface texture of frustrating layer 306, bulk scattering within frustrating layer 306, or incomplete contact between compliant waveguide 304 and frustrating layer 306. For instance, some of the radiation that escapes from compliant waveguide 304 may travel in a direction away from frustrating layer 306, while some of the escaped radiation may travel towards frustrating layer 306. As a result, a portion of the escaped radiation, as shown by arrows “B” in FIG. 3, may never reach the SIP display 120. One approach to enable capture of a sufficient amount of light from the frustrated TIR to yield position, despite the escaped radiation that never is imaged, may be to increase the intensity of the radiation injected into the pliable waveguide 304. This approach, however, may cause operating efficiency to be diminished. Therefore, an alternative approach may be to configure frustrating layer 306 to collect and/or steer radiation that escapes compliant waveguide 304 and that is incident on frustrating layer 306 toward the SIP display 120.

In implementations in which frustrating layer 306 is configured to collect and/or steer radiation that escapes compliant waveguide 304 and that is incident on layer 306, frustrating layer 306 may be configured to steer escaped radiation to within a range of angles such that the escaped radiation is steered towards a position that is substantially beneath the point of contact between compliant waveguide 304 and frustrating layer 306. By collecting and steering radiation towards the optimal area of the SIP display 120, the operating efficiency may be increased. As a result, less powerful radiation sources 302 may be used, and stray light issues may be reduced. Furthermore, by steering more of the FTIR escaped radiation towards the SIP display 120, the probability of failing to sense contact may be reduced. The frustrating layer may be formed from an engineered material having light-steering microstructures formed within or on a surface of the engineered material, with the light-steering microstructures being configured to steer radiation/light in one or more particular directions.

In some cases, the engineered microstructures which are employed on or within frustrating layer include diffractive optical elements (DOEs). In general, a DOE structure is a structure that includes a pattern of refractive index variations on the order of a wavelength of light and which primarily diffracts incident radiation. A DOE structure can be generated digitally or recorded optically as an interference pattern between two wavefronts of coherent light. In some implementations, the patterns of refractive index variations in the DOEs may be formed by transferring an interference pattern to material such that a series of fringes representing intensity minima and maxima of the interference pattern correspond to the patterns of refractive index variation. For example, interference patterns can be transferred to a recording material using techniques such as interference lithography. The pattern can be represented by a periodic, random, semi-random, or mathematically complex, deterministic variation of refractive index or thickness across one or more different materials. In some cases, the fringes of the transferred interference pattern correspond to a grating structure. Depending on the design and construction, a DOE structure transmits or reflects incident radiation in one or more directions. DOE structures can include surface diffusing structures that are formed on or within a surface of a material, or volume diffusing structures that are formed integrally through at least a portion of the material bulk.

DOE structures include a class of structures called holographic optical elements (HOE) that may be considered to fall within two categories: thin hologram structures and thick (volume) hologram structures. In general, thin hologram structures include surface structures or planes of refractive index variation that vary substantially perpendicularly to the surface on which the radiation is incident and are generally used to transmissively steer a range of wavelengths into one or more particular directions. They can be used in conjunction with a separate reflective element, such as a mirror, to operate reflectively. Thick hologram structures, on the other hand, can include planes of refractive index variations that run substantially parallel to the surface on which radiation is incident, and generally use Bragg selectivity to reflect or transmit a narrow range of wavelengths incident at one or more specific incident angles into one or more particular directions.

In some implementations, the planes of refractive index variations in the HOEs may be formed by transferring an interference pattern to material such that a series of fringes representing intensity minima and maxima of the interference pattern correspond to the planes of refractive index variation. For example, interference patterns can be transferred to a recording material using techniques such as interference lithography. In some cases, the fringes of the transferred interference pattern correspond to a grating structure.

Optical modeling software packages are available to facilitate the design of thin or thick hologram structures to direct radiation in a desired direction. Code V® is one example of such an optical modeling software package that can be used to design thin or thick hologram structures to direct radiation in a desired direction. Other optical modeling software packages also are available.

Any of the techniques and structures described in co-pending, commonly owned U.S. patent application Ser. No. 12/757,693, entitled “Touch Sensing,” filed Apr. 9, 2010, which is incorporated herein by reference in its entirety for all purposes, may be applied to the frustrating layer 306.

Regarding the photosensors used in the SIP display 120, a-Si:H is insensitive to infrared light (wavelengths longer than ˜700 nm), especially at the low thicknesses (few tenths of microns) characteristic of TFT fabrication. A-Si:H has a bandgap of 1.7 eV. In some implementations, a hydrogenated silicon germanium alloy (a-SiGe:H) or microcrystalline silicon can be used in a photosensor to extend the photoresponse further into the infrared spectrum (longer wavelengths) compared to a-Si:H. For example, a-SiGe:H with a bandgap of 1.4 eV would be sensitive to 850 nm light. However, a-SiGe:H is also still sensitive to visible light as well. Techniques are described below to reduce the visible photosensitivity of such a material while maintaining the IR photosensitivity needed for FTIR touch sensing.

FIG. 4 illustrates an example photosensor array 400. The photosensor array 400 may be used in the SIP display 120 with the photosensor array 400 including a photosensor for each pixel in the SIP display 120. Although FIG. 4 illustrates nine photosensors for brevity, the photosensor array 400 may include many more photosensors.

The photosensors in the photosensor array 400 are based on materials compatible with the TFT process and are sensitive to infrared (IR) light and less so or not at all to visible light. The TFT process is commonly based on a-Si:H, but can also be based on polysilicon or amorphous semiconducting oxide materials such as amorphous Indium Gallium Zinc Oxide (IGZO). As shown, each of the photosensors in the photosensor array 400 is a two-layer photosensor with a top layer 410 and a bottom layer 420. The top layer 410 absorbs visible light, roughly 400-700 nm, and mostly transmits light with a wavelength longer than 700 nm. The transmitted light is thereupon incident on the bottom layer 420, which may be an a-SiGe:H photosensing layer, microcrystalline silicon or low bandgap amorphous semiconducting oxide. Depending on the germanium content, the a-SiGe:H is sensitive to some of the transmitted near infrared light, ideally in the range of 700 to 880 nm. In general, a-SiGe:H may be preferred to microcrystalline silicon as the bottom photosensor material because a-SiGe:H has much higher absorption coefficient, thus a much thinner layer may be used. This is more compatible with TFT fabrication times and processes. However, microcrystalline silicon may be used in some implementations. It is understood that a similar structure could be devised in the case of an amorphous semiconducting oxide by choosing the alloy composition such that the top layer has roughly a 1.7 to 1.8 eV bandgap to absorb visible light and the bottom layer of lower bandgap to detect infrared light.

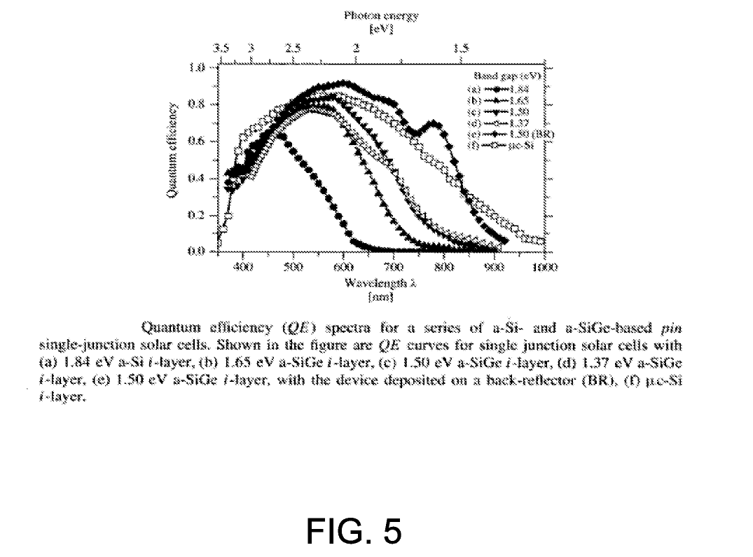

FIG. 5 shows quantum efficiency versus wavelength for solar cells with photosensitive layers having a range of bandgaps, the highest being a-Si:H and the lowest being microcrystalline silicon. In between, there are layers that have increasing amounts of germanium and correspondingly lower bandgaps. The quantum efficiency is a good representation of the optical absorption of the layer. To implement the disclosed two-layer photosensor shown in FIG. 4, a top layer 410 with effective bandgap of 1.7 to 1.8 eV may be used. With this bandgap, most visible light will be absorbed.

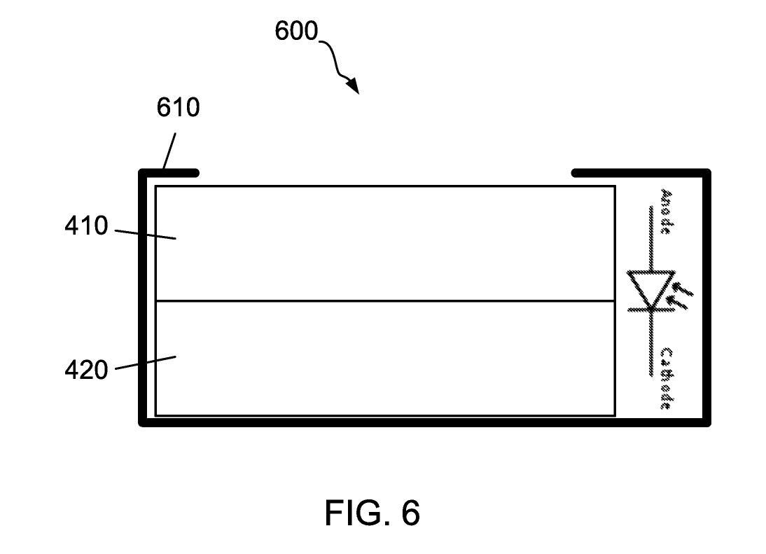

FIG. 6 illustrates an example of a photosensor 600 that may be used in the photosensor array 400. As shown in FIG. 6, the photosensor 600 includes a photodetector 610 (e.g., a photodiode or photodiode device). In the photosensor 600, the top layer 410 and the bottom layer 420 are part of the photodetector 610. In this example, electricity flows through the top layer 410 and the bottom layer 420 in detecting light (e.g., infrared light) incident on the photodetector 610. Accordingly, because electricity flows through the top layer 410, which serves as a filter for visible light, the material used in the top layer 410 may be designed to limit the impact of the top layer 410 in sensing only infrared light. In this regard, the top layer 410 may be designed to limit the photocurrent generated in absorbing visible light.

Unlike a solar cell, the top layer 410 may have very low quantum efficiency for generating photocurrent. The following summarizes various possibilities for implementing an upper visible filter layer 410 that generates little or no photocurrent. It is important to note that it is desirable to not affect the performance of the photodiode or phototransistor, so the conductivity of the layer 410 should be factored in.

In some implementations, thick (˜0.2-0.5 micron) highly doped p-type or n-type amorphous silicon may be used for the top layer 410. The high boron or phosphorus content in the layer 410 will assure low photogenerated carrier lifetime and thus low visible light photocurrent in a photodiode implementation. The thickness can be optimized to absorb the most visible light while not adding too much series resistance to the diode.

In some examples, ternary alloy may be used for the top layer 410. It is generally known that amorphous silicon bandgap is reduced by adding germanium and increased by adding nitrogen, oxygen or carbon. It is also known that electrical properties, such as photosensitivity, are significantly reduced with alloying, especially in the case of ternary alloys. A layer of bandgap ˜1.7 eV may be prepared among these ternary alloys with proper ratios of germanium and nitrogen, oxygen or carbon: a-SiGeN, a-SiGeO, or a-SiGeC:H layer. A-SiGeN:H may be desirable because a-SiN:H is typically used as a gate dielectric in the fabrication of TFT's. Plasma enhanced chemical vapor deposition (PECVD) systems have the provisions for depositing SiN from silane and ammonia gas. A-SiGeN:H may be formed from PECVD in a similar manner using silane, germane and ammonia. This approach may be used in the case of a phototransistor design, where this layer's poor conductivity is less of a concern.

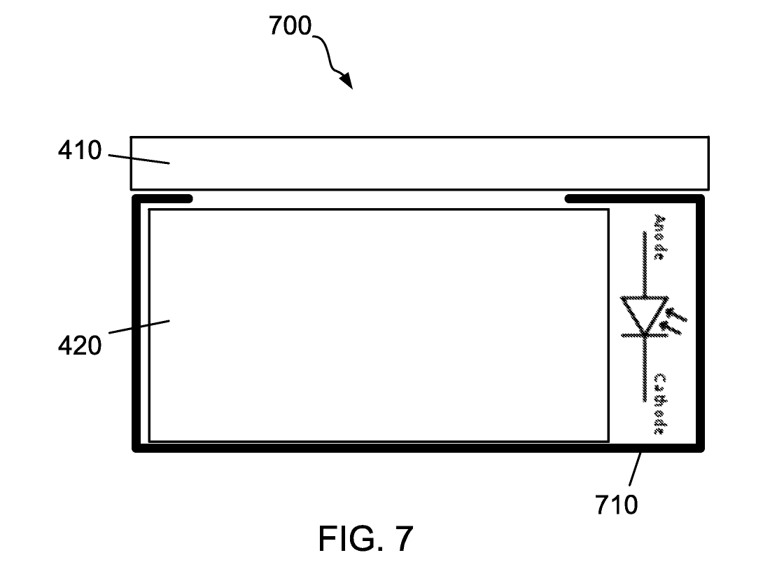

FIG. 7 illustrates another example of a photosensor 700 that may be used in the photosensor array 400. As shown in FIG. 7, the photosensor 700 includes a photodetector 710 (e.g., a photodiode or photodiode device). In the photosensor 700, the bottom layer 420 is part of the photodetector 710 and the top layer 410 is not. The top layer 410 is outside of the photodetector 710 itself and simply functions as an optical filter “window” positioned over the photodetector 710. In this example, electricity flows through the bottom layer 420 in detecting light (e.g., infrared light) incident on the photodetector 710, but electricity does not flow through the top layer 410. Accordingly, because electricity does not flow through the top layer 410, the material used for the top layer 410 may be chosen with a lessened concern for the photocurrent generated in absorbing visible light. Any of the materials described throughout this disclosure may be used for the top layer 410 in the photosensor 700.

A number of implementations have been described. Nevertheless, it will be understood that various modifications may be made.

In some of the disclosed implementations, FTIR based touch sensors may be used with sensor-in-pixel displays, and touch events may be registered based on changes in light observed by photosensors in the sensor-in-pixel displays that result from light escaping from the FTIR-based touch sensors as a consequence of contact being made with the waveguide by appropriate input mechanisms, such as, for example, fingers. Any type of FTIR-based touch sensor may be used. For example, the sensor-in-pixel displays and photosensor technology described throughout this disclosure may be integrated with the FTIR-based touch sensors described in co-pending, commonly owned U.S. patent application Ser. No. 12/757,693, entitled “Touch Sensing,” filed Apr. 9, 2010; co-pending, commonly owned U.S. patent application Ser. No. 12/757,937, entitled “Touch Sensing,” filed Apr. 9, 2010; and co-pending, commonly owned U.S. patent application Ser. No. 12/791,663, entitled “Touch Sensing,” filed Jun. 1, 2010. U.S. patent application Ser. Nos. 12/757,693, 12/757,937, and 12/791,663 are incorporated herein by reference in their entireties for all purposes.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A touch-sensitive display device comprising:
an infrared light source;
a waveguide configured to receive infrared light emitted by the light source and to cause at least some of the received infrared light to undergo total internal reflection within the waveguide;
a frustrating layer disposed relative to the waveguide so as to contact the waveguide when a touch input is provided, the frustrating layer being configured to cause frustration of the total internal reflection of the received infrared light within the waveguide at a contact point between the frustrating layer and the waveguide such that some of the received infrared light undergoing total internal reflection within the waveguide escapes from the waveguide at the contact point; and
a sensor-in-pixel display configured to display an image that is perceivable through the waveguide and the frustrating layer and including photosensors, the photosensors having a photosensor corresponding to each pixel of the image and being configured to sense at least some of the infrared light that escapes from the waveguide at the contact point.

2. The touch-sensitive display device of claim 1, wherein each of the photosensors is sensitive to infrared light and less sensitive to visible light as compared to infrared light.

3. The touch-sensitive display device of claim 1, wherein each of the photosensors is sensitive to infrared light and insensitive to visible light.

4. The touch-sensitive display device of claim 1, wherein each of the photosensors includes:
a first layer that is configured to absorb visible light and transmit infrared light; and
a second layer that is configured to sense infrared light transmitted through the first layer.

5. The touch-sensitive display device of claim 1, wherein each of the photosensors includes:
a first layer that is configured to absorb light having a wavelength between 400 and 700 nanometers and transmit light having a wavelength longer than 700 nanometers; and
a second layer that is configured to sense light having a wavelength between 700 and 880 nanometers that is transmitted through the first layer.

6. The touch-sensitive display device of claim 1, wherein each of the photosensors comprises a hydrogenated silicon germanium alloy (a-SiGe:H).

7. The touch-sensitive display device of claim 1, wherein each of the photosensors comprises microcrystalline silicon.

8. The touch-sensitive display device of claim 1, wherein each of the photosensors includes:
a first layer with an effective bandgap of 1.7 to 1.8 eV; and
a second layer that is configured to sense light transmitted through the first layer.

9. The touch-sensitive display device of claim 1, wherein each of the photosensors includes:
a first layer that has a thickness of about 0.2 to 0.5 microns and comprises highly doped p-type amorphous silicon; and
a second layer that is configured to sense light transmitted through the first layer and that comprises at least one of a hydrogenated silicon germanium alloy (a-SiGe:H) and microcrystalline silicon.

10. The touch-sensitive display device of claim 1, wherein each of the photosensors includes:
a first layer that has a thickness of about 0.2 to 0.5 microns and comprises highly doped n-type amorphous silicon; and
a second layer that is configured to sense light transmitted through the first layer and that comprises at least one of a hydrogenated silicon germanium alloy (a-SiGe:H) and microcrystalline silicon.

11. The touch-sensitive display device of claim 1, wherein each of the photosensors includes:
a first layer that comprises a ternary alloy; and
a second layer that is configured to sense light transmitted through the first layer and that comprises at least one of a hydrogenated silicon germanium alloy (a-SiGe:H) and microcrystalline silicon.

12. The touch-sensitive display device of claim 11, wherein the ternary alloy includes a ratio of germanium and nitrogen (a-SiGeN).

13. The touch-sensitive display device of claim 11, wherein the ternary alloy includes a ratio of germanium and oxygen (a-SiGeO).

14. The touch-sensitive display device of claim 11, wherein the ternary alloy includes a ratio of germanium and carbon (a-SiGeC:H).

15. The touch-sensitive display device of claim 11, wherein the ternary alloy comprises an a-SiGeN:H layer.

16. The touch-sensitive display device of claim 1:
wherein the frustrating layer is a pliable frustrating layer disposed relative to the waveguide so as to enable the pliable frustrating layer to contact the waveguide when the pliable frustrating layer is physically deformed; and
wherein the pliable frustrating layer is configured to cause frustration of the total internal reflection of the received infrared light within the waveguide at a contact point between the pliable frustrating layer and the waveguide when the pliable frustrating layer is physically deformed to contact the waveguide such that some of the received infrared light undergoing total internal reflection within the waveguide escapes from the waveguide at the contact point.

17. The touch-sensitive display device of claim 16, wherein the waveguide contacts the sensor-in-pixel display.

18. The touch-sensitive display device of claim 1:
wherein the waveguide is a pliable waveguide;
wherein the frustrating layer is disposed relative to the pliable waveguide so as to enable the frustrating layer to contact the pliable waveguide when the pliable waveguide is physically deformed; and
wherein the frustrating layer is configured to cause frustration of the total internal reflection of the received infrared light within the pliable waveguide at a contact point between the frustrating layer and the pliable waveguide when the pliable waveguide is physically deformed to contact the frustrating layer such that some of the received infrared light undergoing total internal reflection within the pliable waveguide escapes from the pliable waveguide at the contact point.

19. The touch-sensitive display device of claim 18, wherein the frustrating layer contacts the sensor-in-pixel display.

20. The touch-sensitive display device 1, further comprising a cladding layer positioned to receive a touch input and cause the waveguide and the frustrating layer to contact based on the touch input.

21. The touch-sensitive display device of claim 1, wherein each of the photosensors comprises a photodetector that includes a first layer configured to filter visible light and a second layer configured to sense infrared light transmitted through the first layer, wherein electricity generated by the photodetector in sensing infrared light flows through each of the first layer and the second layer.

22. The touch-sensitive display device of claim 1, wherein each of the photosensors comprises a first layer configured to filter visible light and a photodetector that includes a second layer configured to sense infrared light transmitted through the first layer, wherein the first layer is positioned as a window over the photodetector and electricity generated by the photodetector in sensing infrared light flows through the second layer, but does not flow through the first layer.
